(19) United States
(12) Patent Application Publication
(10) Pub. No.: US 2013/0012670 A1
(43) Pub. Date: Jan. 10, 2013

(54) SEALANT OF LIQUID CRYSTAL PANEL AND MODIFICATION METHOD THEREFOR

(75) Inventors: Weiwei Zhang, Shenzhen (CN); Rui Xu, Shenzhen (CN); Hongqing Huang, Shenzhen (CN); Junjie Huang, Shenzhen (CN); Quan Liu, Shenzhen (CN)

(73) Assignee: SHENZHEN CHINA STAR OPTOELECTRONICS TECHNOLOGY CO., LTD., Shenzhen (CN)

(21) Appl. No.: 13/263,749

(22) PCT Filed: Jul. 13, 2011
(86) PCT No.: PCT/CN11/77117

§ 371 Date: Oct. 10, 2011

(30) Foreign Application Priority Data
Jul. 5, 2011 (CN) 201110186878.5

(51) Int. Cl. C08G 18/10; C08G 59/14

(52) U.S. Cl. 525/528

(57) ABSTRACT

A sealant of a liquid crystal panel and a modification method therefor are disclosed. The sealant contains modified epoxy resins which is formed by a cross-linking and curing reaction between isocyanate-terminated tri-functional monomers and epoxy monomers. The modified epoxy resin has a plurality of trifurcate cross-linking long-chain structures, and each of the trifurcate cross-linking long-chain structures has three isocyanate groups, each of which is flexibly linked to one or more molecular groups of epoxy resin. The modified epoxy resin can enhance the adhesion property of the epoxy resin with surfaces of glass substrates and the stress-and-cracking resistance of the epoxy resin, while it can efficiently prevent from the miscible material problem between the epoxy resin and the liquid crystal material, so as to relatively lower the possibility of contaminating the liquid crystal material.

### FIELD OF THE INVENTION

The present invention relates to a sealant of a liquid crystal panel and a modification method therefor, and more particularly to a sealant of a liquid crystal panel which uses isocyanate-terminated tri-functional monomers to modify epoxy and a modification method therefor.

### BACKGROUND OF THE INVENTION

Liquid crystal displays (LCDs) have been widely applied to various electronic products, wherein most of the LCDs are backlight type LCDs, each of which is constructed by a liquid crystal panel and a backlight module. Referring now to FIG. 1, a structure of a traditional liquid crystal panel 10 generally comprises: two transparent glass substrates 11, 12; a sealant 13 coated between the two glass substrates 11, 12; and a liquid crystal material 14 encapsulated in a space enclosed by the sealant 13. For the installation process of the liquid crystal panel 10, the liquid crystal material 14 can be encapsulated between the two transparent glass substrates 11, 12 and in the sealant 13 by conventionally feasible methods including: the vacuum siphon method and the one drop filling (ODF) method.

The vacuum siphon method comprises steps of: firstly pre-coating a ring-like sealant 13 on a glass substrate 11 and preserving an inlet (not-shown) for the sealant 13; then aligning the glass substrate 11 with the other glass substrate 12 and attaching thereto, followed by curing the sealant 13 by ultraviolet (UV) light or other means; after this, placing the two glass substrates 11, 12 into a vacuum environment and allowing the inlet to be in contact with the liquid crystal material 14; then breaking the vacuum to cause the liquid crystal material 14 to spontaneously enter the sealant 13 under the atmospheric pressure; and finally sealing the inlet of the sealant 13, so as to finish a semi-product of the liquid crystal panel 10.

On the other hand, the one drop filling (ODF) method comprises steps of: firstly coating a complete ring-like sealant 13 on a glass substrate 11; then dropping the liquid crystal material 14 onto the surface of the glass substrate 11 within the sealant 13 by a liquid crystal dropping device (not shown); and finally attaching the glass substrate 11 to the other glass substrate 12 and curing the sealant 13, so as to finish a semi-product of the liquid crystal panel 10.

The liquid crystal material 14 used by the liquid crystal panel 10 generally has a structure of formula (1), as follows:

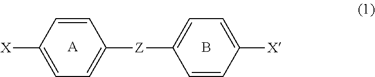

Wherein A and B are aromatic rings, such as phenyl or cyclohexane group, which are the main framework of a liquid crystal molecule; X and X′ are terminal groups, one of which is generally alkyl.

Furthermore, the sealant 13 used by the liquid crystal panel 10 is generally made of epoxy resin, wherein the epoxy resin has many excellent performances, such as higher strength and modulus, better chemical and thermal stabilities, lower shrinkage, better adhesion property and etc. The epoxy resin is generally formed by a curing reaction of cross-linking polyamine or polyol monomers having R₁ of hydroxyl (or aromatic group) with epoxy monomers having R₂ of hydroxyl (or aromatic group), wherein the curing reaction is shown as the following formulas (2), (3) and (4):

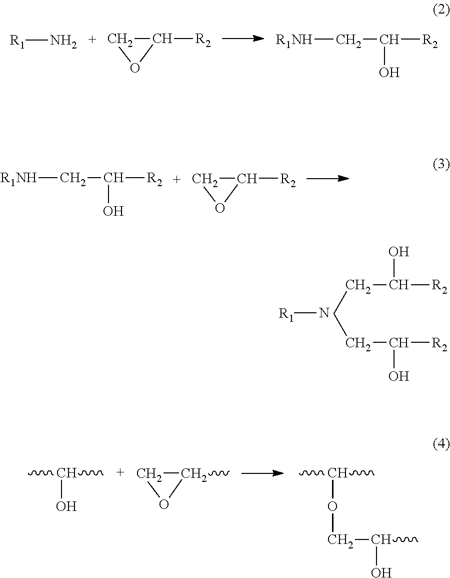

Moreover, according to Invention patents including Japanese Patent Laid-Open Publication No. 2004-244515, Japanese Patent Laid-Open Publication No. 2007-079588 and US Patent Publication No. 2006/0208219, epoxy resin used as the sealant 13 is generally belonged to bisphenol-A type epoxy resin, i.e. it uses bisphenol-A as polyol monomers.

However, referring now to FIG. 2, the problem of a traditional bisphenol-A type epoxy resin is that a molecular chain 130 of the bisphenol-A type epoxy resin generally has a too high cross-linking density and the bonding rigidity of the molecular chain 130 is too strong, so as to substantially limit the flexible motion of the molecular chain 130. As a result, it may easily cause many disadvantages, such as increase brittleness of material, lower impact resistance, deteriorate the wetting property with the glass substrates 11, 12, easily generate cracks and etc., resulting in affecting the reliability of a sealing structure of the sealant 13. In addition, based on the miscible principle of similar compounds, the bisphenol-A type epoxy resin and the liquid crystal material 14 have aromatic groups and the polarity thereof are similar, so that a small amount of the epoxy resin of the sealant 13 may be dissolved and leaked into the liquid crystal material 14. As a result, leaked impurities will contaminate the liquid crystal material 14 and affect the color display quality thereof.

Therefore, it is necessary to provide a sealant of a liquid crystal panel and a modification method therefor to solve the problems existing in the conventional technologies, as described above.

### SUMMARY OF THE INVENTION

As described above, the present invention provides a sealant of a liquid crystal panel and a modification method therefor to solve the problems of miscible risk and contamination of material existing in the conventional technologies.

A primary object of the present invention is to provide a sealant of a liquid crystal panel and a modification method therefor, which uses isocyanate-terminated tri-functional monomers to modify epoxy resin for enhancing the adhesion property of the epoxy resin with surfaces of glass substrates and the stress-and-cracking resistance of the epoxy resin, while it can efficiently prevent from occurring the miscible material problem between the epoxy resin and the liquid crystal material, so as to relatively lower the possibility of contaminating the liquid crystal material.

To achieve the above object, the present invention provides a modification method for a sealant of a liquid crystal panel, wherein the modification method comprises the following steps of:

providing isocyanate-terminated tri-functional monomers and epoxy monomers; and

mixing the isocyanate-terminated tri-functional monomers with the epoxy monomers to carry out a cross-linking and curing reaction therebetween, so as to form a modified epoxy resin;

wherein the modified epoxy resin has a plurality of trifurcate cross-linking long-chain structures, and each of the trifurcate cross-linking long-chain structures has three isocyanate groups, each of which is flexibly linked to one or more molecular groups of epoxy resin.

In one embodiment of the present invention, in the step of providing the isocyanate-terminated tri-functional monomers and the epoxy monomers, the isocyanate-terminated tri-functional monomers are pre-formed by reacting diisocyanate reactants with tri-functional reactants, wherein the following formula (5) represents that the diisocyanate reactants react with the tri-functional reactants to form the isocyanate-terminated tri-functional monomers, wherein each of the tri-functional reactants has a trifurcate long-chain structure to provide a suitably flexible structural property, and each of long chains of the trifurcate long-chain structures is preferably a straight carbon chain, and each of the straight carbon chains preferably has a carbon number greater than 6, such as 6, 7, 8, 8, 10 or more.

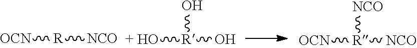

In one embodiment of the present invention, the diisocyanate reactants are selected from hexamethylene diisocyanate (HDI, OCN(CH₂)₆NCO), toluene diisocyanate (TDI, C₉H₈N₂O₂, including two isomers of 2,4-TDI and 2,6-TDI) or diphenylmethane 4,4′-diisocyanate (MD₁, C₁₅H₁₀N₂O₂), and preferably HDI.

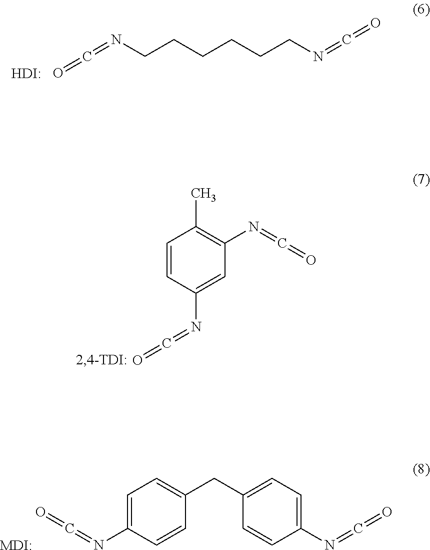

In one embodiment of the present invention, the tri-functional reactants are selected from polyether triol, polycaprolactone triol or carboxylate tri-polymer, and preferably polyether triol.

In one embodiment of the present invention, the molar reaction ratio between isocyanate groups (—NCO) of the diisocyanate reactants and hydroxyl groups (—OH) or carboxyl groups (—COON) of the tri-functional reactants is ranged from 1.2:1 to 1.8:1, and preferably 1.4:1.

In one embodiment of the present invention, the molar reaction ratio between epoxy groups of the epoxy monomers and isocyanate groups of the isocyanate-terminated tri-functional monomers is ranged from 1:1 to 4:1, and preferably 3:1.

In one embodiment of the present invention, the modified epoxy resin is aromatic epoxy resin.

In one embodiment of the present invention, the epoxy monomers are selected from epichlorohydrin (C₃H₅ClO) or other aromatic epoxy resin monomers.

In one embodiment of the present invention, the epoxy monomers are selected from bisphenol-A type epoxy resins.

Furthermore, the present invention further provides a sealant of a liquid crystal panel, wherein the sealant comprises a modified epoxy resin, wherein the modified epoxy resin is formed by a cross-linking and curing reaction between isocyanate-terminated tri-functional monomers and epoxy monomers, the modified epoxy resin has a plurality of trifurcate cross-linking long-chain structures, and each of the trifurcate cross-linking long-chain structures has three isocyanate groups, each of which is flexibly linked to one or more molecular groups of epoxy resin.

Referring to the isocyanate-terminated tri-functional monomers as shown in the formula (5), after the cross-linking and curing reaction with the epoxy monomers, each of three isocyanate-terminated groups of the isocyanate-terminated tri-functional monomers are reacted with the epoxy monomers, so as to form three isocyanate groups, each of which is flexibly linked to one or more molecular groups of epoxy resin, i.e. each of the trifurcate cross-linking long-chain structures is flexibly linked to three molecular groups of the epoxy resins.

When the epoxy monomers of the cross-linking and curing reaction use the bisphenol-A type epoxy resins, it will form a structure of modified epoxy resin 200 as shown in FIG. 3, wherein the modified epoxy resin 200 is a modified bisphenol-A type epoxy resin which has trifurcate cross-linking long-chain structures 21 and a plurality of molecular groups of bisphenol-A type epoxy resin 22, wherein the trifurcate cross-linking long-chain structures 21 and the bisphenol-A type epoxy resin 22 are linked to each other through the isocyanate groups 23.

### DESCRIPTION OF THE DRAWINGS

FIG. 1 is a schematic view of a structure of a traditional liquid crystal panel;

FIG. 2 is a schematic view of rigid cross-linking molecular chains of a traditional bisphenol-A type epoxy resin; and

FIG. 3 is a schematic view of flexibly cross-linking molecular chains of a modified epoxy resin according to a preferred embodiment of the present invention.

### DETAILED DESCRIPTION OF THE PREFERRED EMBODIMENTS

The structure and the technical means adopted by the present invention to achieve the above and other objects can be best understood by referring to the following detailed description of the preferred embodiments and the accompanying drawings.

1. Experimental Material:

diisocyanate reactants, tri-functional reactants (also called suitably flexible reactants), acetone or butanone, bromophenol blue, dibutylamine, HCl, toluene, and isopropanol.

The diisocyanate reactants can be selected from hexamethylene diisocyanate (HDI), toluene diisocyanate (TDI) or diphenylmethane 4,4′-diisocyanate (MDI), such as selectively using HDI.

The tri-functional reactants (i.e. suitably flexible reactants) can be selected from polyether triol, polycaprolactone triol or carboxylate tri-polymer, such as selectively using polyether triol.

The epoxy monomers can be selected from epichlorohydrin or other aromatic epoxy resin monomers, and preferably bisphenol-A type epoxy resins.

All of the foregoing solvents or other material must be processed in advance to a refined degree.

2. Experimental Apparatuses:

Electric mixer, a vacuum pump with circulated water system, a viscometer, a tabletop centrifuge, a infrared spectroscopy (FTIR) and a liquid chromatography-mass spectrometry (LC-MS).

3. Synthesis of Modified Epoxy Resin:

(1) Material Weighing and Dehydration:

Firstly, weighting HDI and polyether triol, both of which are weighted according to the molar reaction ratio between isocyanate groups (—NCO) and hydroxyl group (or carboxyl group) ranged from 1.2:1 to 1.8:1, such as 1.2:1, 1.4:1, 1.6:1 or 1.8:1, wherein the preferable ratio is 1.4:1.

Then, adding the polyether triol into a dried four-neck flask installed with a thermometer, a stirrer and a reflux condenser, and pumping up to a vacuum condition more than 0.09 MPa, and more preferably 0.098 MPa. After the vacuum condition meets the setting value, slowly heating to rise the temperature up to 100 to 140° C. for dehydration, wherein the dehydration temperature is preferably ranged from 100° C. to 120° C., and the dehydration is keeping until the polyether triol has no bubbles emerging and all tubes has no condensed water.

After the dehydration, cooling down to a temperature below 50° C.

(preferable below 20° C.), and then breaking the vacuum condition.

(2) Initial Polymerization Of Synthesizing Isocyanate-Terminated Tri-Functional Monomers:

Stirring and increasing the temperature to 60-95° C., and slowly adding the hexamethylene diisocyanate (HDI) by dropping. During dropping, controlling the dropping speed, wherein 10 g of HDI is dropped about 20 mins; and then reacting about 1.5-5.5 hrs (preferably 2.5 hrs) under a temperature-keeping environment. During reacting, suitably adding acetone or butanone to lower the system viscosity, wherein the adding amount of acetone or butanone is 25% of total weight of HDI and the polyether triol. When HDI and the polyether triol are completely reacted, macromolecular products of isocyanate-terminated tri-functional monomers can be obtained. The content measurement of isocyanate groups (—NCO) in the products is that: because the isocyanate groups can be reacted with dibutylamine to form urea, the remaining dibutylamine can be measured by dropping a standard solution of HCl, so as to calculate the content of isocyanate groups.

(3) Modification of Epoxy Resin:

Mixing the epoxy monomers with the isocyanate-terminated tri-functional monomers according to the molar reaction ratio between epoxy groups and isocyanate groups (ranged from 1:1 to 4:1), such as epoxy groups:isocyanate groups=3:1; and keeping the reaction between the epoxy groups and the isocyanate groups about 0.5-4 hrs (preferably 1 hr) at the temperature of 120° C., in order to prepare a modified epoxy resin having trifurcate cross-linking long-chain structures with suitable flexibility and stronger polarity.

(4) Characteristic of Modified Epoxy Resin:

Reaction degree: sampling modified epoxy resins in different reaction stages, wherein each of samples thereof are coated on a chip of KBr salt, and FTIR is used to observe the area of peaks of various functional groups, in order to determine the degree of the cross-linking and curing reaction;

Test of adhesion property and stress-and-cracking resistance: coating the modified epoxy resin on a substrate for being used as a sealant, and testing the peel strength of the sealant, wherein the peel destruction method is interface destruction;

Detection of contamination for liquid crystal material: using the modified epoxy resin as a sealant which is coated on an inner bottom of a sample bottle in a planar manner; then dropping the liquid crystal material on the sealant; keeping about 1 hr at a temperature of 120° C., and finally using LC-MS to detect if the liquid crystal material contains any composition of the sealant and the content thereof;

Storage stability: using a centrifugal acceleration sedimentation experiment to simulate the storage stability of the modified epoxy resin (sealant);

4. Advantageous Effect:

Stronger adhesion property and stress-and-cracking resistance: because the toughness of the modified epoxy resin is enhanced, it is relatively difficult to peel the sealant off from the substrate. Thus, the adhesion property and the stress-and-cracking resistance of the sealant are enhanced.

Lower contamination for liquid crystal material: detecting by LC-MS, and sampling a sample of the liquid crystal material after dropping about 9.5 min for detection, wherein the sealant composition (modified epoxy resin) present in the liquid crystal material has a peak area smaller than that of the traditional sealant composition therein about 30%.

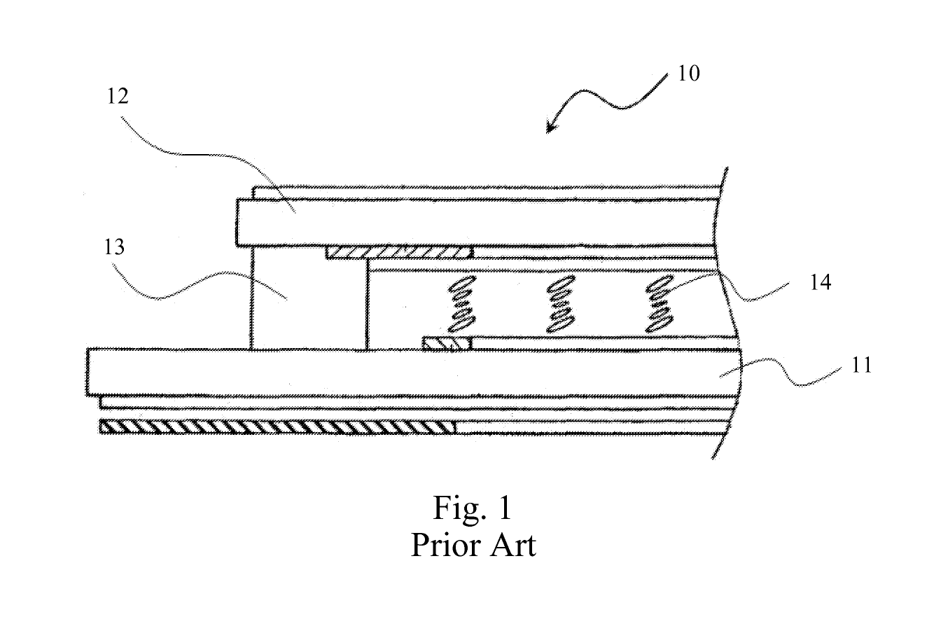

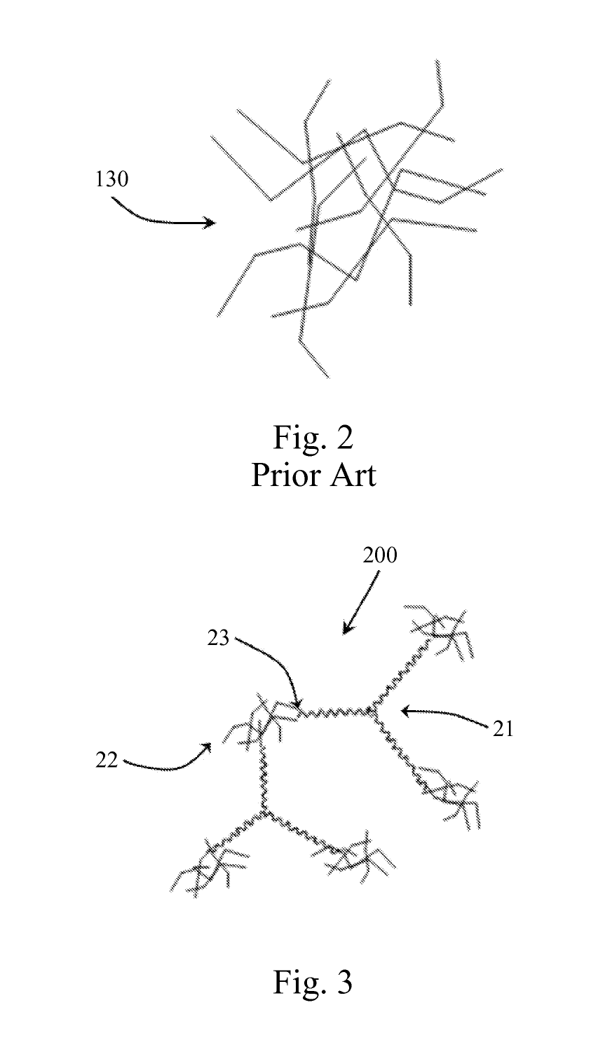

As described above, the traditional sealant of the liquid crystal panel as shown in FIGS. 1 and 2 is made of bisphenol-A type epoxy resin, the cross-linking density between the molecular chain 130 thereof is generally too high, and the bonding rigidity of the molecular chain 130 is too strong, so that it substantially limits the flexible motion of the molecular chain 130 and thus may easily cause many disadvantages, such as increase brittleness of material, lower impact resistance, deteriorate the wetting property with the glass substrates 11, 12, easily generate cracks and etc., resulting in affecting the reliability of a sealing structure of the sealant 13. In addition, if the traditional bisphenol-A type epoxy resin is used as the sealant 13, a small amount of the epoxy resin of the sealant 13 may be dissolved and leaked into the liquid crystal material 14. As a result, leaked impurities will contaminate the liquid crystal material 14 and affect the color display quality thereof. In comparison, the sealant of the liquid crystal panel according to the present invention uses the modified epoxy resin 200 (such as modified bisphenol-A type epoxy resin) which comprises: trifurcate cross-linking long-chain structures 21 and a plurality of molecular groups of bisphenol-A type epoxy resin 22, wherein the trifurcate cross-linking long-chain structures 21 and the molecular groups of bisphenol-A type epoxy resin 22 are linked to each other through the isocyanate groups 23, so that the molecular chains have partially cross-linking structures and surely have suitably flexibility. Thus, the cohesive strength of the adhesive used as the sealant can be enhanced, while the wetting property of the modified epoxy resin 200 with the glass substrates can be maintained. As a result, the better adhesion property and stress-and-cracking resistance can be obtained. In addition, the present invention also can efficiently prevent the miscible material problem between the modified epoxy resin 200 and the liquid crystal material 14, so as to relatively lower the possibility of contaminating the liquid crystal material 14 by the modified epoxy resin 200.

The present invention has been described with a preferred embodiment thereof and it is understood that many changes and modifications to the described embodiment can be carried out without departing from the scope and the spirit of the invention that is intended to be limited only by the appended claims.

1. A modification method for a sealant of a liquid crystal panel,
characterized in that: the modification method comprises steps of:
providing isocyanate-terminated tri-functional monomers and epoxy monomers, wherein the isocyanate-terminated tri-functional monomers are pre-formed by reacting diisocyanate reactants with carboxylate tri-polymers, the diisocyanate reactants are selected from hexamethylene diisocyanate, toluene diisocyanate or diphenylmethane 4,4′-diisocyanate; and
mixing the isocyanate-terminated tri-functional monomers with the epoxy monomers to carry out a cross-linking and curing reaction therebetween, so as to form a modified epoxy resin;
wherein the modified epoxy resin has a plurality of trifurcate cross-linking long-chain structures, and each of the trifurcate cross-linking long-chain structures has three isocyanate groups, each of which is flexibly linked to one or more molecular groups of epoxy resin; and each of long chains of the trifurcate cross-linking long-chain structures is a straight carbon chain having a carbon number greater than 6.

2. The modification method for a sealant of a liquid crystal panel according to claim 1, characterized in that: the epoxy monomers are selected from epichlorohydrin or aromatic epoxy resin monomers.

3. The modification method for a sealant of a liquid crystal panel according to claim 1, characterized in that: the epoxy monomers are selected from bisphenol-A type epoxy resins.

4. The modification method for a sealant of a liquid crystal panel, characterized in that: the modification method comprises steps of:
providing isocyanate-terminated tri-functional monomers and epoxy monomers, wherein the isocyanate-terminated tri-functional monomers are pre-formed by reacting diisocyanate reactants with carboxylate tri-polymers; and
mixing the isocyanate-terminated tri-functional monomers with the epoxy monomers to carry out a cross-linking and curing reaction therebetween, so as to form a modified epoxy resin;
wherein the modified epoxy resin has a plurality of trifurcate cross-linking long-chain structures, and each of the trifurcate cross-linking long-chain structures has three isocyanate groups, each of which is flexibly linked to one or more molecular groups of epoxy resin.

5. (canceled)

6. The modification method for a sealant of a liquid crystal panel according to claim 4, characterized in that: the diisocyanate reactants are selected from hexamethylene diisocyanate, toluene diisocyanate or diphenylmethane 4,4′-diisocyanate.

7. (canceled)

8. The modification method for a sealant of a liquid crystal panel according to claim 4, characterized in that: the molar reaction ratio between isocyanate groups of the diisocyanate reactants and carboxyl groups of the carboxylate tri-polymer is ranged from 1.2:1 to 1.8:1.

9. The modification method for a sealant of a liquid crystal panel according to claim 4, characterized in that: the molar reaction ratio between epoxy groups of the epoxy monomers and isocyanate groups of the isocyanate-terminated tri-functional monomers is ranged from 1:1 to 4:1.

10. The modification method for a sealant of a liquid crystal panel according to claim 4, characterized in that: the epoxy monomers are selected from epichlorohydrin or aromatic epoxy resin monomers.

11. The modification method for a sealant of a liquid crystal panel according to claim 4, characterized in that: the epoxy monomers are selected from bisphenol-A type epoxy resins.

12. The modification method for a sealant of a liquid crystal panel according to claim 4, characterized in that: each of long chains of the trifurcate cross-linking long-chain structures is a straight carbon chain having a carbon number greater than 6.

13-16. (canceled)
